(19) United States
(12) Patent Application Publication
(10) Pub. No.: US 2026/0214635 A1
(43) Pub. Date: Jul. 23, 2026

(54) IDENTIFYING GEOGRAPHIC LOCATIONS FOR HOME ROUTED ROAMERS USING PACKET INSERTION

(71) Applicant: T-Mobile USA, Inc., Bellevue, WA (US)

(72) Inventors: Geoffrey Todd GIBSON, Ben Wheeler, TX (US); Romil Kumar SOOD, Bothell, WA (US); Thomas Joesph CAST, Redmond, WA (US); Rushabhkumar PATEL, Newcastle, WA (US); Erik Karel KOSAR, Newcastle, WA (US); Mark Gregory CLANCY, Bellevue, WA (US); Eric Paul JENSEN, Snohomish, WA (US)

(21) Appl. No.: 19/034,499

(22) Filed: Jan. 22, 2025

(51) Int. Cl. H04W 64/00; H04W 8/04; H04W 8/06

(52) U.S. Cl. CPC H04W 64/006; H04W 8/04; H04W 8/06

(57) ABSTRACT

Disclosed solutions enable identification of the true location of roaming user equipment (UE) that are receiving Home Routing services, and have assigned IP addresses that are publicly associated with the country of the UEs'home mobile network operator (MNO). This permits security controls, which limit access to internet-exposed assets according to the country in which a device is located, to correctly identify the locations of UEs. Multiple solutions may be used individually or in combination: An association of a UE's assigned IP address, with the visited wireless network's mobile country code (MCC), is posted while Home Routing is ongoing. The visited wireless network's MCC is injected into packets that the home MNO places onto the internet. The home MNO's set of assignable IP addresses are separated into pools each labeled with a roaming destination's MCC; this scheme is used to assign IP address to UEs and is publicized for lookup.

### BACKGROUND

Modern cellular networks, such as fourth generation (4G) and fifth generation (5G) cellular networks and likely later generations, often support Home Routing Roaming which makes it possible for a telecommunication service provider to provide and manage services for a customer that is roaming into another provider's network, such as when traveling abroad. Calls, messages, data, and internet access are processed through the customer's home network rather than the foreign network within the country that the customer is visiting. Thus, when a user equipment (UE, e.g., cellphone) is roaming-into another provider's network (whether internationally or within the same country), and tries to use the internet, the UE's home mobile network operator (MNO) assigns one of its own (assignable) IP addresses to the UE.

Unfortunately, this has the potential to create security risks or violations of security policies. There are internet-exposed assets (e.g., data and software applications) that are intended for access only by devices within certain countries. Devices physically located within some countries are prohibited, by policy, from accessing those assets. Security controls typically check the internet protocol (IP) address of a device requesting access to such an asset, performing a geolocation lookup process to ascertain the country associated with the device's IP address, and determine whether to grant or deny access based on that country. However, a UE that is roaming within a prohibited country, that has Home Routing service from within a permitted country, has an IP address that is associated with the customer's home MNO which will, in most cases, be identified as a permitted country.

The security controls are thus likely to improperly grant access to the UE that is in a prohibited country. This may be further exacerbated if the UE acts as a mobile hotspot, and has unknown and untrusted tethered devices (whether using WiFi, Bluetooth, or another communication protocol) that are also able to access the internet using the UE's IP address.

### SUMMARY

The following summary is provided to illustrate examples disclosed herein, but is not meant to limit all examples to any particular configuration or sequence of operations.

Solutions are disclosed that enable identifying geographic locations for home routed roamers. Examples receive, by a first wireless network (e.g., home network), from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identify, by the first wireless network, the visited (wireless) network and the visited country and the visited network; publish, at a network location server accessible by the network resource, an indication of the visited country or the visited network associated with the first IP address; and forward, by the first wireless network, the data packet to the network resource.

Additional examples receive, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identify, by the first wireless network, the visited (wireless) network and the visited country; insert, into the data packet, an indication of the visited country or the visited network; and forward, by the first wireless network, the data packet to the network resource.

Additional examples publish, at a network location server accessible by a network resource, a set of indications of visited countries each associated with a pool of assignable IP addresses; identify, by a first wireless network, that a UE is roaming on a visited wireless network operating in a visited country, wherein the UE comprises a home subscriber of the first wireless network; identify, by the first wireless network, the visited country and the visited network; assign, by the first wireless network, to the UE, a first IP address, wherein the first IP address indicates a first country in which the first wireless network operates but does not indicate the visited country and the visited network, and wherein the first IP address is assigned in accordance with the visited country or the visited network and the set of indications of visited countries; receive, by the first wireless network, from the UE, a data packet addressed to a network resource across a computer network; and forward, by the first wireless network, the data packet to the network resource.

Additional examples receive, by a first wireless network, from a UE, a data packet addressed to a network resource across a computer network, wherein the UE is roaming on a visited wireless network, wherein the UE comprises a home subscriber of the first wireless network; identify, by the first wireless network, the network resource to which the data packet is addressed; based on at least identifying the network resource, select from among a set of actions to identify the visited country or the visited network, the set of actions including: publishing, at a network location server accessible by the network resource, an indication of the visited country or the visited network associated with the first IP address; inserting, into the data packet, an indication of the visited country or the visited network; and assigning, to the UE, a first IP address in accordance with the visited country or the visited network and a set of indications of visited countries each associated with a pool of assignable IP addresses; and perform the selected action to identify the visited country or the visited network.

### BRIEF DESCRIPTION OF THE DRAWINGS

The disclosed examples are described below with reference to the accompanying drawing figures listed below, wherein:

FIG. 1 illustrates an exemplary architecture that advantageously identifies geographic locations for home routed roamers;

FIG. 2 illustrates a potential security incident scenario when using prior art wireless networks;

FIG. 3A illustrates further detail for identifying geographic locations for home routed roamers in examples of the architecture of FIG. 1;

FIG. 3B illustrates further detail for aspects of FIG. 3A;

FIGS. 4A, 4B, and 4C illustrate further detail, relative to FIG. 3A, of each of three different solution scenarios that may be used with examples of the architecture of FIG. 1;

FIGS. 5, 6A, 6B, 6C, and 6D illustrate flowcharts of exemplary operations associated with the architecture of FIG. 1; and

FIG. 7 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Disclosed solutions enable identification of the true location of a roaming user equipment (UE) that is receiving Home Routing Roaming service (“Home Routing”), and has an assigned internet protocol (IP) address that is publicly associated with the country of the UE's home mobile network operator (MNO). This permits security controls, which limit access to internet-exposed assets (e.g., data and software applications) according to the country in which a requesting device is located, to correctly identify the location of a UE that is using Home Routing. Three solutions are disclosed that may be used individually or in any combination: An association of the IP address assigned to the UE with the visited (wireless) network's mobile country code (MCC) or a mobile network code (MNC) is posted in real-time, during the period of provision of Home Routing service. The visited network's MCC is injected into packets that the home MNO places onto the internet. The home MNO's set of assignable IP addresses are separated into pools that are each labeled with the MCC of a potential UE roaming destination, with this scheme then used to assign the IP address to roaming UEs and publicized for lookup. Security controls may then use any of the identifications methods to identify the true location of roaming UEs.

Aspects of the disclosure improve security for network resources (e.g., websites) that are reached over the internet using wireless services, by enabling security controls to make correctly-informed decisions about allowing or denying services to roaming UEs that are receiving Home Routing service. Although examples are described primarily for preventing network resource access for UEs roaming within a foreign country, the inventive concepts described extend to preventing network resource access for UEs roaming on visited networks within the home country.

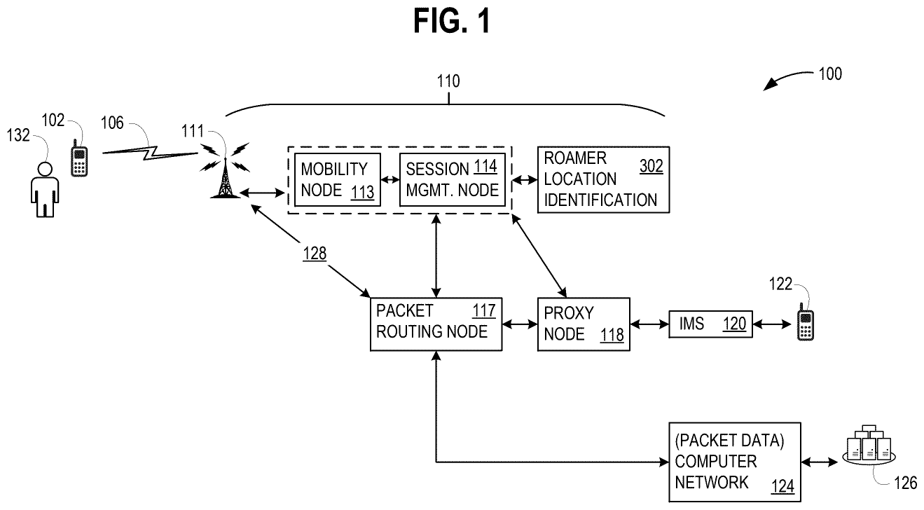

With reference now to the figures, FIG. 1 illustrates an exemplary architecture 100 that advantageously provides for identifying geographic locations for home routed roamers. A wireless network 110 is illustrated that is serving a UE 102 for a wireless subscriber 132. UE 102 may be an enhanced mobile broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network.

In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 106 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

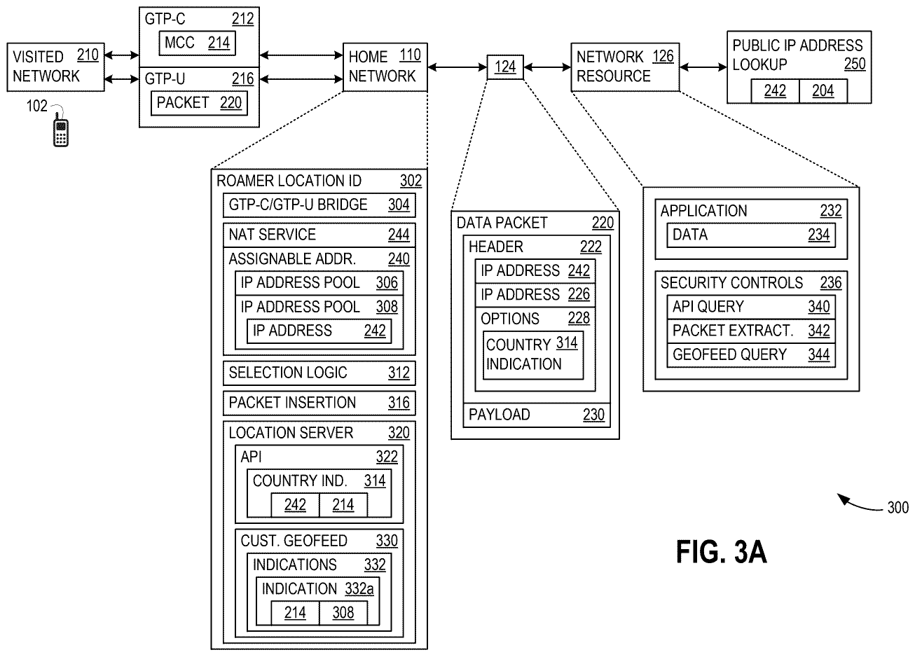

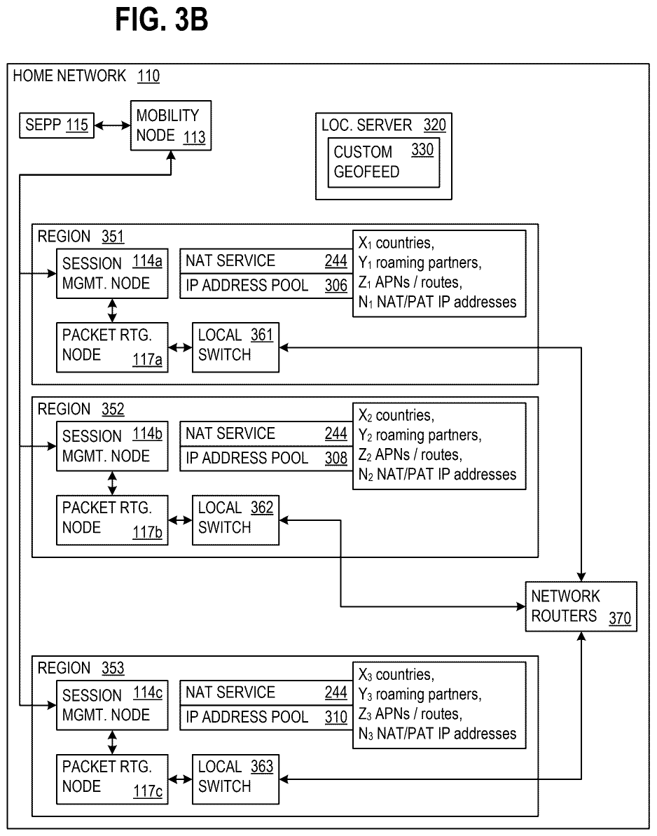

As illustrated in further detail in the remaining figures (starting with FIG. 3), and described more fully below in relation to the other figures, roamer location identification 302 uses any one or more of three solutions to enable network resource 126 to identify the true location of UE 102 when UE 102 is roaming and using Home Routing services.

Although FIG. 1 and some of the following figures are described using an example of a cellular network, it should be understood that the teachings herein are applicable to other types of wireless networks. To benefit from the teachings herein, another wireless network, other than a cellular network, should provide a service that is similar to Home Routing, in that user devices that are roaming are assigned IP addresses that are publicly associated with the location of the wireless network, rather than the user device's roaming location. With such features, another type of wireless network, other than a cellular network, may also benefit from the disclosure herein.

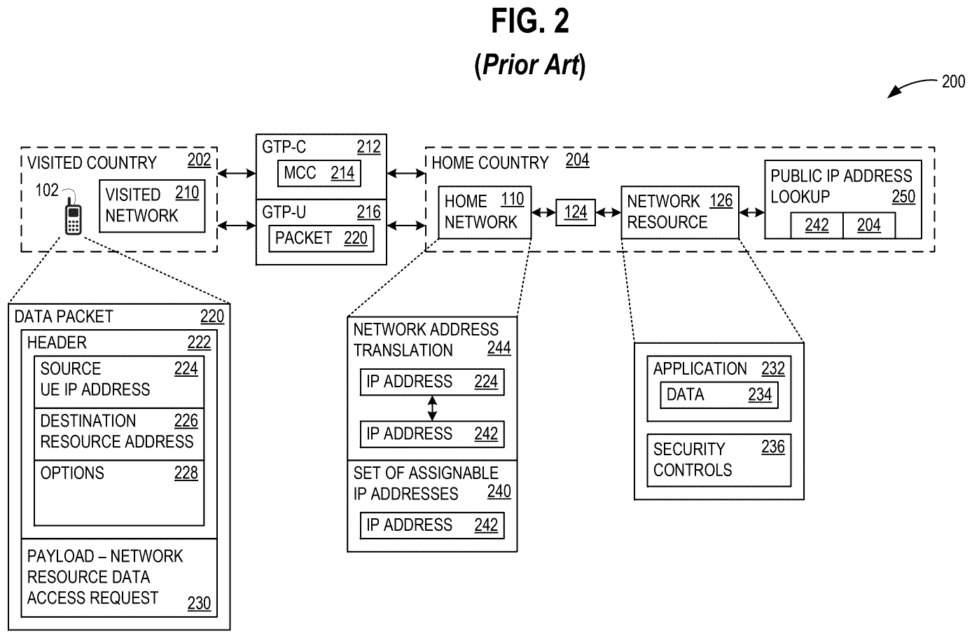

FIG. 2 illustrates a potential security incident scenario 200 when using prior art cellular (wireless) networks. UE 102, which is a home subscriber of wireless network 110, is within a visited country 202, using a visited wireless network 210 as a roamer. Visited wireless network 210, which operates within visited country 202, informs wireless network 110 that it is serving UE 102 as the local (to UE 102) network. Wireless network 110 operates within a country 204, and is the home MNO of UE 102. In this scenario, then, country 204 is the home country of UE 102.

Visited wireless network 210 and wireless network 110 communicate using a general packet radio service (GPRS) tunneling protocol (GTP) control plane (GTP-C) channel 212 for control plane signals (e.g., call signaling) and a GTP user plane (GTP-U) channel 216 for data signals (e.g., user data packets). Visited wireless network 210 passes its MCC 214 to wireless network 110 over GTP-C channel 212, and passes a data packet 220 from UE 102 (destined for network resource 126) over GTP-U channel 216.

While roaming within visited country 202, UE 102 attempts to reach an internet exposed application 232 hosted by network resource 126, and/or data 234 hosted by network resource 126. When UE 102 attempts to communicate with network resource 126 over computer network 124 (e.g., the internet), it uses a private IP address 224 assigned to it by wireless network 110. A network address translation (NAT) service 244 swaps this to a public IP address 242 (for external traffic) from a set of assignable IP addresses 240 that wireless network 110 has available to assign dynamically to the UEs it serves. It is wireless network 110, rather than visited wireless network 210 that places data traffic for UE 102 onto the internet (i.e., places data packet 220 onto computer network 124). NAT service 244 may be, for example, a Carrier Grade NAT (CGNAT) solution. In some examples, NAT service 244 includes Port Address Translation (PAT) capability.

Data packet 220 has a header 222 with a source identified as IP address 242 and a destination identified as IP address 226 of network resource 126. In traditional formatting, header 222 also has an options field 228 (which will be used as described later), and a payload 230. In some examples, payload 230 may comprise at least a portion of a transport layer security (TLS) connection request. TLS is a cryptographic protocol designed to provide communications security over a computer network, such as the Internet.

Wireless network 110 places data packet 220 onto computer network 124, where it is routed to network resource 126. Security controls 236 at network resource 126 are configured to permit (allow) access to internet exposed application 232 and data 234 for devices that are within country 204, but deny access to internet exposed application 232 and data 234 for devices that are within visited country 202. So, security controls 236 extract IP address 242 from header 222 of data packet 220 (the purported source of data packet) and perform a lookup using a public IP address geolocation service 250, such as WhoIs.

Public IP address geolocation service 250 has IP address 242 identified as being from country 204, which is correct, because it is assigned to wireless network 110 that operates within country 204. However, in this scenario, IP address 242 is assignable by wireless network 110 to the UEs that it serves, and it has been assigned to UE 102 that is actually not within country 204, but is instead within visited country 202. Security controls 236 then improperly allow UE 102 to access network resource 126 and data 234 on network resource 126, which may be a security violation.

To enable security controls 236 to avoid making this mistake, three solutions for correctly identifying the true geographic location of UE 102 are shown in an arrangement 300 of FIG. 3A. Roamer location identification 302 is shown as providing three different solutions: (1) Wireless network 110 posts (in real-time) an association of IP address 242, assigned to UE 102 (via NAT service 244), with MCC 214 of visited wireless network 210 on a location server 320, while wireless network 110 provides Home Routing service to UE 102. (2) Wireless network 110 injects MCC 214 of visited wireless network 210 into data packet 220. (3) Wireless network 110 separates its set of assignable IP addresses 240 into different pools, each labeled with an MCC of a roaming partner, assigns IP address 242 to UE 102 (via NAT service 244) in accordance with this scheme, and posts this information on location server 320. Any one of these solutions may be used alone or in combination with any of the others. In some examples, another indication of visited country 202 is used in place of MCC 214.

Roamer location identification 302 of wireless network 110 has a bridge 304 between GTP-C channel 212 and GTP-U channel 216, so that MCC 214 of visited wireless network 210 may be inserted into data packet 220 by a packet insertion logic 316. Set of assignable IP addresses 240 is separated into multiple pools, each of which may be a range of contiguous IP addresses. An IP address pool 306 is shown, along with an IP address pool 308 that contains IP address 242. IP address pool 308 is reserved for UEs that are roaming on visited wireless network 210, such as UE 102, whereas IP address pool 308 is reserved for UEs that are roaming on a different visited network, such as in a different visited country. Although only two IP address pols are shown it should be understood that the number of pools may be the same or similar to the count of international roaming partners of wireless network 110.

In some scenarios, roamer location identification 302 looks into data packets to identify the destination IP address, and if anything is known about the destination, one of the three solutions for identifying the visited country or the visited network is selected for that destination. For example, selection logic 312 inspects header 222 of data packet, identifies IP address 226 of network resource 126, and selects one (or more) of the solutions which network resource 126 is able to leverage. In some examples, one, two, or three of the solutions are applied without selecting specifically for data traffic destinations.

Packet insertion logic 316 inserts an indication 314 of visited country 202 into data packet 220, such as within header 222, perhaps within options field 228. In some examples, indication 314 of visited country 202 is or comprises MCC 214 of visited wireless network 210, although in some examples, a different indication may be used. Additionally, or instead, network location server 320 has indication 314 of visited country 202 associated with IP address 242 posted in real time and accessible through an application programming interface (API) 322. Further additionally or instead, network location server 320 has a custom geolocation feed (geofeed) 330 with a set of indications 332 of visited countries or visited networks that indicate which countries or wireless networks are associated with the different IP address pools (e.g., IP address pools 306 and 308). For example, an indication 332a (within set of indications 332) shows that IP address pool 308 (which contains IP address 242) is for visited country 202. This may take the form of that IP address pool 308 being labeled with indication 314 of visited country 202 or visited network 210 (e.g., MCC 214 or an MNC). With respect to identifying a country for IP address 242, it should be noted that custom geofeed 330 of wireless network 110 differs from public IP address geolocation service 250.

Security controls 236 of network resource 126 has one, two, or all three of an API query 340, packet extraction logic 342, and custom geofeed query 344 in order to identify that UE 102 is within visited country 202, instead of country 202. API query 340 queries API 322 on location server 320 to identify indication 314 of visited country 202 associated with IP address 242. Packet extraction logic 342 extracts indication 314 of visited country 202 from data packet 220. Custom geofeed query 344 is subscribed to custom geofeed 330 and/or queries custom geofeed 330 to identify indication 332a and ascertain indication 314 of visited country 202 based on IP address 242 being within IP address pool 308.

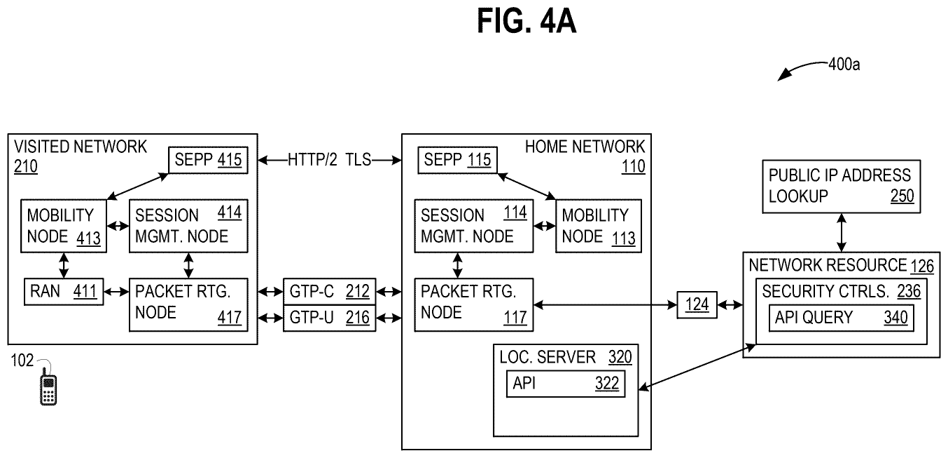

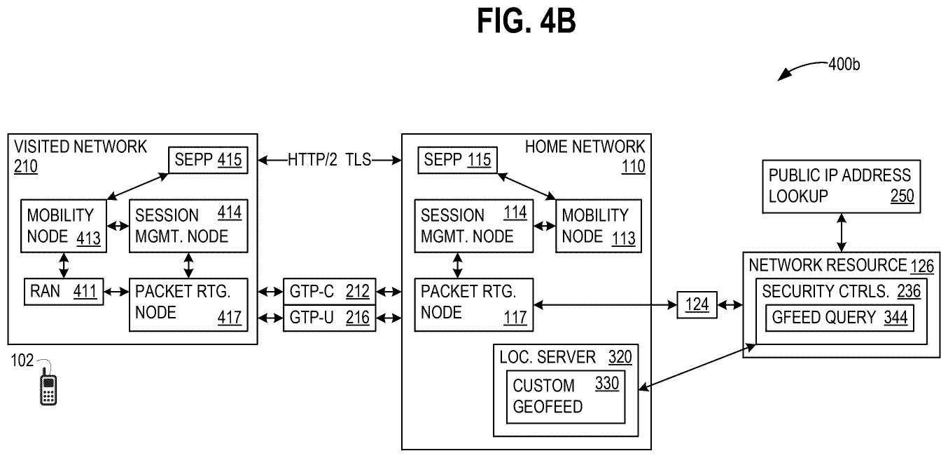

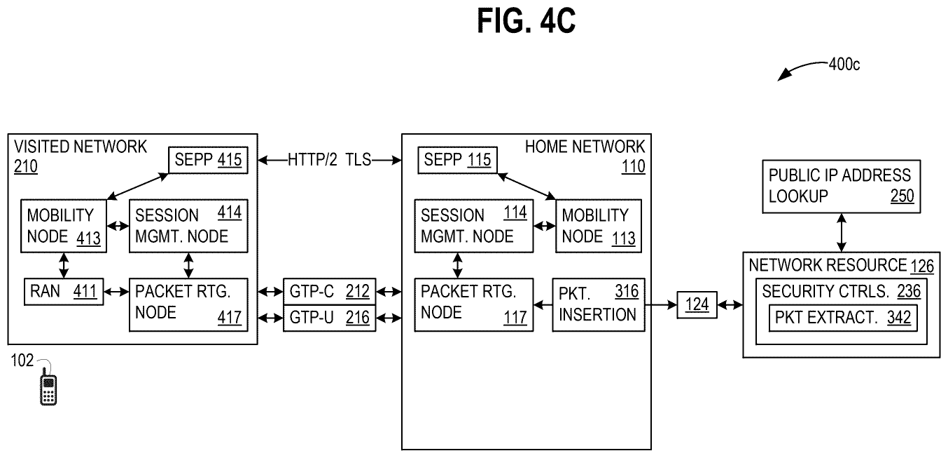

FIG. 3B illustrates further detail for the IP Address pools of FIG. 3A. Wireless network 110 has a security edge protection proxy (SEPP) 115, which communicates with a SEPP 415 of visited wireless network 210 (shown in FIG. 4A). A SEPP enhances security for interconnect signaling between different MNOs. Packet routing nodes of wireless network 110 communicates with a packet routing node 417 of visited wireless network 210 (shown in FIG. 4A) using GTP-C channel 212 and GTP-U channel 216. As illustrated, wireless network 110 has three packet routing nodes 417a-417c, each of which is equivalent to packet routing node 417, described previously.

Three regions are supported for the IP address pools: a region 351, a region 352, and a region 353. Any of regions 351-353 may be a global region, Asia, Africa, Europe, Middle East, South America, Central America, or another region, or any combination or subset of the aforementioned regions. Region 351 has a session management node 114a (which is an equivalent of session management node 114, described previously) and a local switch 361 that connects to network routers 370. Region 351 uses IP address pool 306 and supports X₁ countries with Y₁ roaming partners, has Z₁ access point names (APNs) with Z₁ routes, and N₁ NAT/PAT public IP addresses available.

Region 352 has a session management node 114b and a local switch 362 that connects to network routers 370. Region 352 uses IP address pool 308 and supports X₂ countries with Y₂ roaming partners, has Z₂ APNs with Z₂ routes, and N₂ NAT/PAT public IP addresses available. Region 353 has a session management node 114c and a local switch 363 that connects to network routers 370. Region 353 uses an IP address pool 310 and supports X₃ countries with Y₃ roaming partners, has Z₃ APNs with Z₃ routes, and N₃ NAT/PAT public IP addresses available.

FIGS. 4A, 4B, and 4C each illustrates further detail, relative to FIG. 3A, of each of the three different solution scenarios being used individually. FIG. 4A shows an arrangement 400a with further detail for the solution in which wireless network 110 posts indication 314 of visited country 202 associated with IP address 242 posted in real time, accessible through an API 322. Visited wireless network 210 has a RAN 411 that communicates wirelessly with UE 102, a mobility node 413, a session management node 414, packet routing node 417, and SEPP 415, which may be corresponding equivalents to base station 111, mobility node 113, session management node 114, packet routing node 117, and a SEPP 115 of wireless network 110, respectively. GTP-C channel 212 and GTP-U channel 216 pass between packet routing node 417 and packet routing node 117, whereas SEPP 415 and SEPP 115 communicate using hypertext transfer protocol version 2 (HTTP/2) and/or TLS.

Upon network resource 126 receiving data packet 220 over computer network 124, security controls 236 performs a lookup of IP address 242 and identifies that it belongs to a wireless network. This means that data packet 220 could be from a roaming UE that is using Home Routing. So security controls 236 uses API query 340 to query API 322 on location server 320 to identify indication 314 of visited country 202 associated with IP address 242. Security controls 236 then determines whether to allow or deny access to internet exposed application 232 and/or data 234 based on learning that the requesting device (UE 102) is within visited country 202.

FIG. 4B shows an arrangement 400b with further detail for the solution in which wireless network 110 separates its set of assignable IP addresses 240 into different pools. Upon network resource 126 receiving data packet 220 over computer network 124, security controls 236 performs a lookup of IP address 242 and identifies that it belongs to a wireless network. This means that data packet 220 could be from a roaming UE that is using Home Routing. So security controls 236 uses custom geofeed query 344 to identify indication 332a and ascertain indication 314 of visited country 202 based on IP address 242 being within IP address pool 308. Security controls 236 then determines whether to allow or deny access to internet exposed application 232 and/or data 234 based on learning that the requesting device (UE 102) is within visited country 202.

FIG. 4C shows an arrangement 400c with further detail for the solution in which wireless network 110 injects indication 314 of visited country 202 into data packet 220. Upon network resource 126 receiving data packet 220 over computer network 124, security controls 236 performs a lookup of IP address 242 and identifies that it belongs to a wireless network. This means that data packet 220 could be from a roaming UE that is using Home Routing. So security controls 236 uses packet extraction logic 342 to extracts indication 314 of visited country 202 from data packet 220. Security controls 236 then determines whether to allow or deny access to internet exposed application 232 and/or data 234 based on learning that the requesting device (UE 102) is within visited country 202.

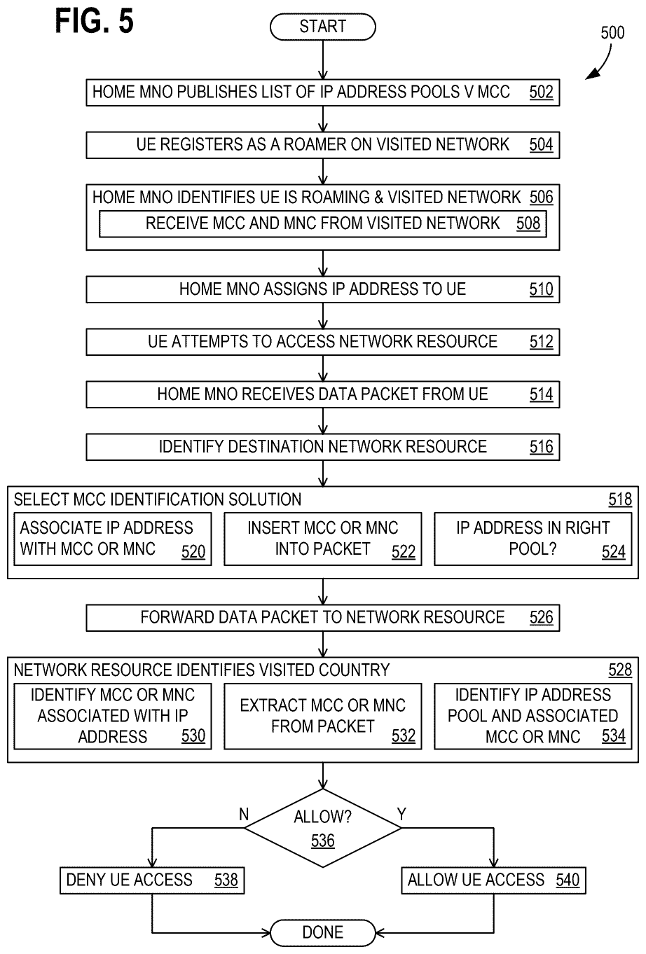

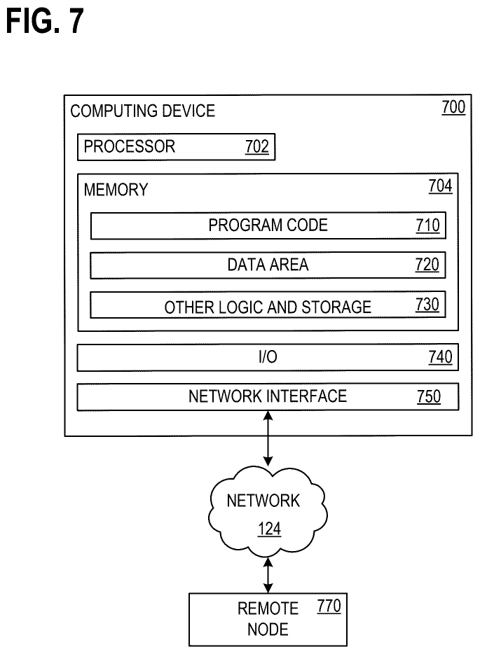

FIG. 5 illustrates a flowchart 500 of exemplary operations associated with examples of architecture 100. In some examples, at least a portion of flowchart 500 may be performed using one or more computing devices 700 of FIG. 7. Flowchart 500 commences with wireless network 110 publishing set of indications 332 of visited countries, each associated with a pool of assignable IP addresses, at network location server 320 so that it is accessible by network resource 126, in operation 502. In some examples, each pool of assignable IP addresses comprises a range of contiguous IP addresses. In some examples, each pool of assignable IP addresses is further differentiated by regions (e.g., cities within visited country 202).

UE 102 registers as a roamer with wireless network 210 in visited country 202 in operation 504. UE 102 comprises a home subscriber of wireless network 110, and may also comprise a cellular phone (e.g., an eMBB), a FWA device, or a computer with a cellular modem. If UE 102 acts as a mobile hotspot, then any downstream tethered devices (whether using WiFi, Bluetooth, or another communication protocol) are also able to access the internet using IP address 242 of UE 102 (as assigned via NAT service 244).

In operation 506, wireless network 110 identifies that UE 102 is roaming on wireless network 210, which is operating in visited country 202. That is, wireless network 110 identifies both wireless network 210 and visited country 202. In some examples, this is accomplished using operation 508, in which wireless network 110 receives MCC 214 (or an MNC) of wireless network 210 from wireless network 210 over GTP-C channel 212. In operation 510, wireless network 110 initiates Home Routing for UE 102 and assigns IP address 242 to UE 102.

IP address 242 indicates country 204 in which wireless network 110 operates (according to public IP address geolocation service 250) but does not indicate visited country 202 (outside of location server 320 of wireless network 110). That is, IP address 242 indicates country 204 in a WhoIs lookup or public IP address geolocation service 250. In some examples, wireless network 110 assigns IP address 242 to UE 102 in accordance with visited country 202 and set of indications 332 of visited countries (i.e., using its IP address pools, such as IP address pool 308 and IP address pool 308).

UE 102 attempts to access internet exposed application 232 and/or data 234, hosted by network resource 126, in operation 512. This involves transmitting data packet 220 to network resource 126, which may comprises at least a portion of a TLS connection request. Wireless network 110 receives data packet 220 from UE 102 (over GTP-U channel 216) in operation 514. Data packet 220 is addressed to network resource 126. In operation 516, wireless network 110 identifies network resource 126 to which data packet 220 is addressed, and in operation 518, based on at least identifying network resource 126 (and what is known about network resource 126, if anything), selection logic 312 selects from among a set of actions to identify visited country 202. One or up to all three solutions may be selected, as operations 520-524.

In operation 520, wireless network 110 publishes indication 314 of visited country 202 or visited network 210 associated with IP address 242. Indication 314 may be MCC 214 or an MNC of wireless network 210. In operation 522, packet insertion logic 316 inserts indication 314 of visited country 202 into data packet 220, (e.g., inserts MCC 214 into header 222). In operation 524 (if not already performed in operation 512 above) wireless network 110 assigns (or reassigns a new) IP address 242 in accordance with visited country 202 or visited network 210 and set of indications 332 of visited countries (or visited networks). Wireless network 110 forwards data packet 220 to network resource 126 across computer network 124 (e.g., the internet), in operation 526. Network resource 126 receives data packet 220.

In operation 528, network resource 126 (e.g., security controls 236 of network resource 126) determines visited country 202 or visited network 210, in order to enable a determination (in decision operation 536 below) whether to deny or allow UE 102 to access to data 234 held by network resource 126 and/or internet exposed application 232. Operation 528 may use any of operations 530-534.

In operation 530, determining visited country 202 comprises querying network location server 320 to identify indication 314 of visited country 202 or visited network 210 associated with IP address 242, such as by querying network location server 320 using API 322. In operation 532, determining visited country 202 or visited network 210 comprises extracting inserted indication 314 of visited country 202 or visited network 210 from data packet 220. In operation 534, determining visited country 202 or visited network 210 comprises querying network location server 320 to identify indication 332a of set of indications 332 of visited countries or visited networks for which IP address 242 is within the pool of assignable IP addresses.

Decision operation 536 determines whether to allow or deny UE 102 access to data 234 and/or internet exposed application 232. If the decision is to deny access, then in operation 538, based on at least visited country 202 or visited network 210 meeting some exclusion criteria, security controls 236 deny UE 102 access to at data 234 held by network resource 126 and/or internet exposed application 232. If the decision is to allow access, then in operation 540, based on at least visited country 202 or visited network 210 meeting some acceptability criteria, security controls 236 allow UE 102 to access to data 234 held by network resource 126 and/or internet exposed application 232.

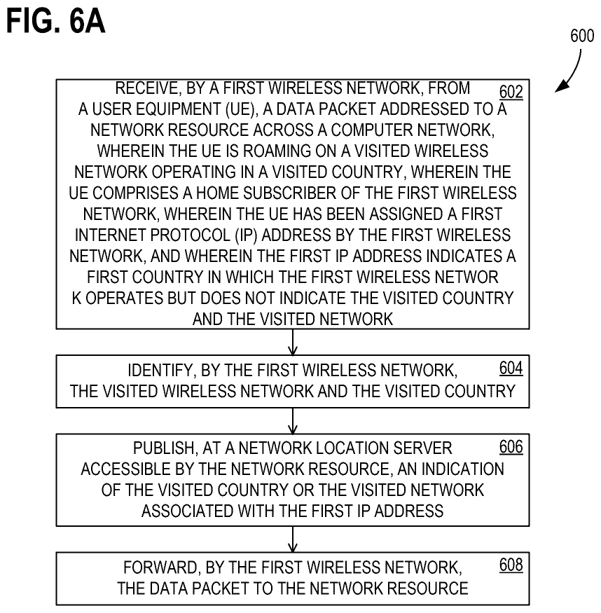

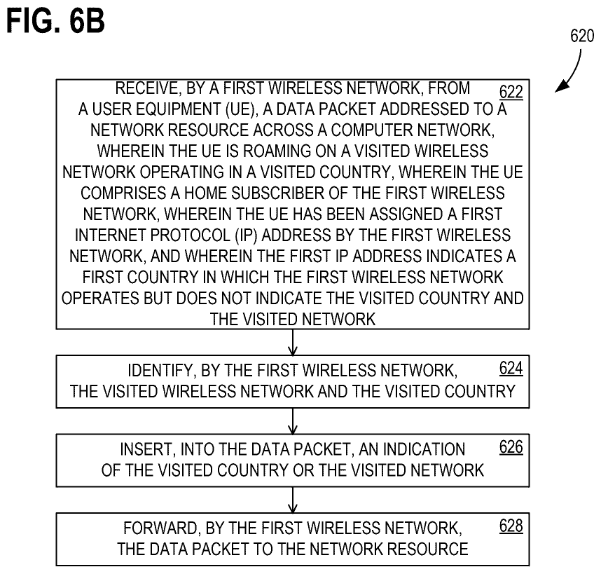

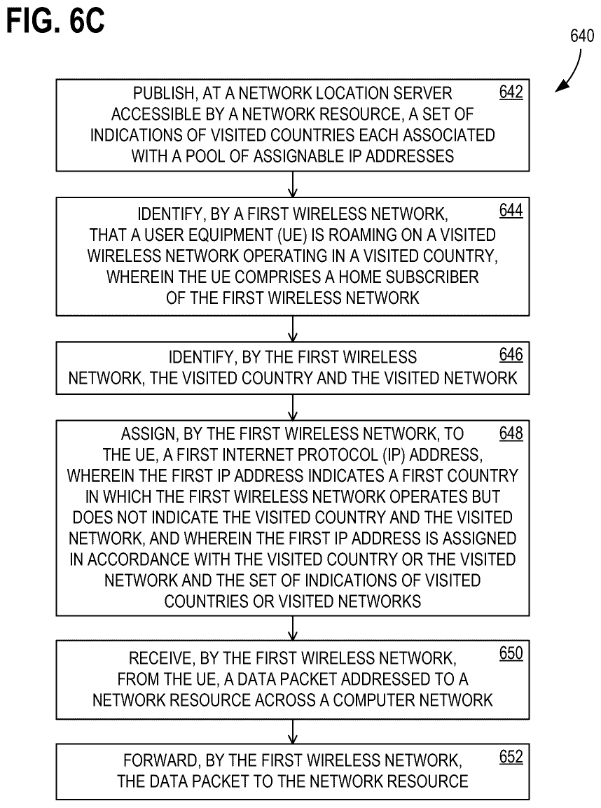

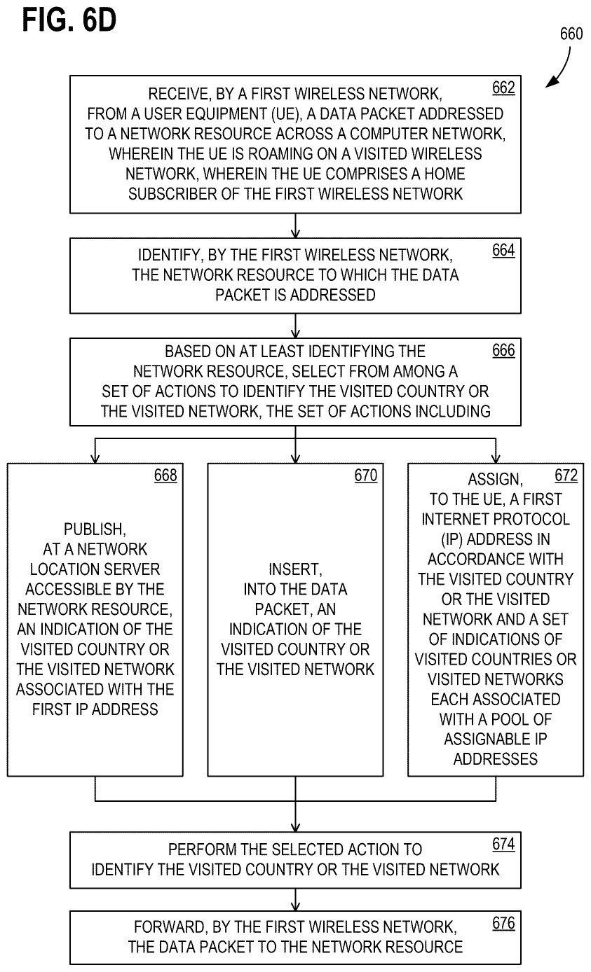

FIG. 6A illustrates a flowchart 600 of exemplary operations associated with architecture 100. In some examples, at least a portion of flowchart 600 may be performed using one or more computing devices 700 of FIG. 7. Flowchart 600 commences with operation 602, which includes receiving, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network.

Operation 604 includes identifying, by the first wireless network, the visited (wireless) network and the visited country. Operation 606 includes publishing, at a network location server accessible by the network resource, an indication of the visited country or the visited network associated with the first IP address. Operation 608 includes forwarding, by the first wireless network, the data packet to the network resource.

FIG. 6B illustrates a flowchart 620 of exemplary operations associated with architecture 100. In some examples, at least a portion of flowchart 620 may be performed using one or more computing devices 700 of FIG. 7. Flowchart 620 commences with operation 622, which includes receiving, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network.

Operation 624 includes identifying, by the first wireless network, the visited (wireless) network and the visited country. Operation 626 includes inserting, into the data packet, an indication of the visited country or the visited network. Operation 628 includes forwarding, by the first wireless network, the data packet to the network resource.

FIG. 6C illustrates a flowchart 640 of exemplary operations associated with architecture 100. In some examples, at least a portion of flowchart 640 may be performed using one or more computing devices 700 of FIG. 7. Flowchart 640 commences with operation 642, which includes publishing, at a network location server accessible by a network resource, a set of indications of visited countries each associated with a pool of assignable IP addresses.

Operation 644 includes identifying, by a first wireless network, that a UE is roaming on a visited wireless network operating in a visited country, wherein the UE comprises a home subscriber of the first wireless network. Operation 646 includes identifying, by the first wireless network, the visited country and the visited network.

Operation 648 includes assigning, by the first wireless network, to the UE, a first IP address, wherein the first IP address indicates a first country in which the first wireless network operates but does not indicate the visited country and the visited network, and wherein the first IP address is assigned in accordance with the visited country or the visited network and the set of indications of visited countries. Operation 650 includes receiving, by the first wireless network, from the UE, a data packet addressed to a network resource across a computer network. Operation 652 includes forwarding, by the first wireless network, the data packet to the network resource.

FIG. 6D illustrates a flowchart 660 of exemplary operations associated with architecture 100. In some examples, at least a portion of flowchart 660 may be performed using one or more computing devices 700 of FIG. 7. Flowchart 660 commences with operation 662, which includes receiving, by a first wireless network, from a UE, a data packet addressed to a network resource across a computer network, wherein the UE is roaming on a visited wireless network, wherein the UE comprises a home subscriber of the first wireless network. Operation 664 includes identifying, by the first wireless network, the network resource to which the data packet is addressed.

Operation 666 includes, based on at least identifying the network resource, selecting from among operations 668-672 to identify the visited country or the visited network. Operation 668 includes publishing, at a network location server accessible by the network resource, an indication of the visited country or the visited network associated with the first IP address. Operation 670 includes inserting, into the data packet, an indication of the visited country or the visited network. Operation 672 includes assigning, to the UE, a first IP address in accordance with the visited country or the visited network and a set of indications of visited countries or visited networks each associated with a pool of assignable IP addresses. Operation 674 includes performing the selected action to identify the visited country or the visited network. Operation 676 includes forwarding, by the first wireless network, the data packet to the network resource.

FIG. 7 illustrates a block diagram of computing device 700 that may be used as any component described herein that may require computational or storage capacity. Computing device 700 has at least a processor 702 and a memory 704 that holds program code 710, data area 720, and other logic and storage 730. Memory 704 is any device allowing information, such as computer executable instructions and/or other data, to be stored and retrieved. For example, memory 704 may include one or more random access memory (RAM) modules, flash memory modules, hard disks, solid-state disks, persistent memory devices, and/or optical disks. Program code 710 comprises computer executable instructions and computer executable components including instructions used to perform operations described herein. Data area 720 holds data used to perform operations described herein. Memory 704 also includes other logic and storage 730 that performs or facilitates other functions disclosed herein or otherwise required of computing device 700. An input/output (I/O) component 740 facilitates receiving input from users and other devices and generating displays for users and outputs for other devices. A network interface 750 permits communication over external computer network 124 with a remote node 770, which may represent another implementation of computing device 700. For example, a remote node 770 may represent another of the above-noted nodes within architecture 100.

### Additional Examples

An example system comprises: a processor; and a computer-readable medium storing instructions that are operative upon execution by the processor to: receive, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identify, by the first wireless network, the visited network and the visited country; publish, at a network location server accessible by the network resource, an indication of the visited country or the visited network associated with the first IP address; and forward, by the first wireless network, the data packet to the network resource.

Another example system comprises: a processor; and a computer-readable medium storing instructions that are operative upon execution by the processor to: receive, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identify, by the first wireless network, the visited network and the visited country; insert, into the data packet, an indication of the visited country or the visited network; and forward, by the first wireless network, the data packet to the network resource.

Another example system comprises: a processor; and a computer-readable medium storing instructions that are operative upon execution by the processor to: publish, at a network location server accessible by a network resource, a set of indications of visited countries each associated with a pool of assignable IP addresses; identify, by a first wireless network, that a UE is roaming on a visited wireless network operating in a visited country, wherein the UE comprises a home subscriber of the first wireless network; identify, by the first wireless network, the visited country and the visited network; assign, by the first wireless network, to the UE, a first IP address, wherein the first IP address indicates a first country in which the first wireless network operates but does not indicate the visited country and the visited network, and wherein the first IP address is assigned in accordance with the visited country or the visited network and the set of indications of visited countries or visited networks; receive, by the first wireless network, from the UE, a data packet addressed to a network resource across a computer network; and forward, by the first wireless network, the data packet to the network resource.

Another example system comprises: a processor; and a computer-readable medium storing instructions that are operative upon execution by the processor to: receive, by a first wireless network, from a UE, a data packet addressed to a network resource across a computer network, wherein the UE is roaming on a visited wireless network, wherein the UE comprises a home subscriber of the first wireless network; identify, by the first wireless network, the network resource to which the data packet is addressed; based on at least identifying the network resource, select from among a set of actions to identify the visited country or the visited network, the set of actions including: publishing, at a network location server accessible by the network resource, an indication of the visited country or the visited network associated with the first IP address; inserting, into the data packet, an indication of the visited country or the visited network; and assigning, to the UE, a first IP address in accordance with the visited country or the visited network and a set of indications of visited countries or visited networks each associated with a pool of assignable IP addresses; and perform the selected action to identify the visited country or the visited network.

An example method of wireless communication comprises: receiving, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identifying, by the first wireless network, the visited network and the visited country; publishing, at a network location server accessible by the network resource, an indication of the visited country or the visited network associated with the first IP address; and forwarding, by the first wireless network, the data packet to the network resource.

Another example method of wireless communication comprises: receiving, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identifying, by the first wireless network, the visited network and the visited country; inserting, into the data packet, an indication of the visited country or the visited network; and forwarding, by the first wireless network, the data packet to the network resource.

Another example method of wireless communication comprises: publishing, at a network location server accessible by a network resource, a set of indications of visited countries each associated with a pool of assignable IP addresses; identifying, by a first wireless network, that a UE is roaming on a visited wireless network operating in a visited country, wherein the UE comprises a home subscriber of the first wireless network; identifying, by the first wireless network, the visited country and the visited network; assigning, by the first wireless network, to the UE, a first IP address, wherein the first IP address indicates a first country in which the first wireless network operates but does not indicate the visited country and the visited network, and wherein the first IP address is assigned in accordance with the visited country or the visited network and the set of indications of visited countries or visited networks; receiving, by the first wireless network, from the UE, a data packet addressed to a network resource across a computer network; and forwarding, by the first wireless network, the data packet to the network resource.

Another example method of wireless communication comprises: receiving, by a first wireless network, from a UE, a data packet addressed to a network resource across a computer network, wherein the UE is roaming on a visited wireless network, wherein the UE comprises a home subscriber of the first wireless network; identifying, by the first wireless network, the network resource to which the data packet is addressed; based on at least identifying the network resource, selecting from among a set of actions to identify the visited country or the visited network, the set of actions including: publishing, at a network location server accessible by the network resource, an indication of the visited country or the visited network associated with the first IP address; inserting, into the data packet, an indication of the visited country or the visited network; and assigning, to the UE, a first IP address in accordance with the visited country or the visited network and a set of indications of visited countries or visited networks each associated with a pool of assignable IP addresses; and performing the selected action to identify the visited country or the visited network.

One or more example computer storage devices has computer-executable instructions stored thereon, which, upon execution by a computer, cause the computer to perform operations comprising: receiving, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identifying, by the first wireless network, the visited network and the visited country; publishing, at a network location server accessible by the network resource, an indication of the visited country or the visited network associated with the first IP address; and forwarding, by the first wireless network, the data packet to the network resource.

One or more additional example computer storage devices has computer-executable instructions stored thereon, which, upon execution by a computer, cause the computer to perform operations comprising: receiving, by a first wireless network, from a UE, a data packet addressed to a network resource across a computer network, wherein the UE is roaming on a visited wireless network operating in a visited country, wherein the UE comprises a home subscriber of the first wireless network, wherein the UE has been assigned a first IP address by the first wireless network, and wherein the first IP address indicates a first country in which the first wireless network operates but does not indicate the visited country and the visited network; identifying, by the first wireless network, the visited network and the visited country; inserting, into the data packet, an indication of the visited country or the visited network; and forwarding, by the first wireless network, the data packet to the network resource.

One or more additional example computer storage devices has computer-executable instructions stored thereon, which, upon execution by a computer, cause the computer to perform operations comprising: publishing, at a network location server accessible by a network resource, a set of indications of visited countries each associated with a pool of assignable IP addresses; identifying, by a first wireless network, that a UE is roaming on a visited wireless network operating in a visited country, wherein the UE comprises a home subscriber of the first wireless network; identifying, by the first wireless network, the visited country or the visited network; assigning, by the first wireless network, to the UE, a first IP address, wherein the first IP address indicates a first country in which the first wireless network operates but does not indicate the visited country and the visited network, and wherein the first IP address is assigned in accordance with the visited country or the visited network and the set of indications of visited countries or visited networks; receiving, by the first wireless network, from the UE, a data packet addressed to a network resource across a computer network; and forwarding, by the first wireless network, the data packet to the network resource.

One or more additional example computer storage devices has computer-executable instructions stored thereon, which, upon execution by a computer, cause the computer to perform operations comprising: receiving, by a first wireless network, from a UE, a data packet addressed to a network resource across a computer network, wherein the UE is roaming on a visited wireless network, wherein the UE comprises a home subscriber of the first wireless network; identifying, by the first wireless network, the network resource to which the data packet is addressed; based on at least identifying the network resource, selecting from among a set of actions to identify the visited country or the visited network, the set of actions including: publishing, at a network location server accessible by the network resource, an indication of the visited country or the visited network associated with the first IP address; inserting, into the data packet, an indication of the visited country or the visited network; and assigning, to the UE, a first IP address in accordance with the visited country or the visited network and a set of indications of visited countries or visited networks each associated with a pool of assignable IP addresses; and performing the selected action to identify the visited country or the visited network.

Alternatively, or in addition to the other examples described herein, examples include any combination of the following:
the wireless network comprises a cellular network;
the UE comprises a cellular phone, an eMBB, an FWA device, or a computer with a cellular modem;
determining, by the network resource, the visited country or the visited network;
based on at least the visited country or the visited network meeting exclusion criteria, denying the UE access to data held by the network resource;
based on at least the visited country or the visited network meeting acceptability criteria, allowing the UE to access to the data held by the network resource;
determining the visited country or the visited network comprises querying the network location server to identify the indication of the visited country or the visited network associated with the first IP address;
determining the visited network comprises querying the network location server to identify the indication of the visited network associated with the first IP address;
querying the network location server comprises querying the network location server using an API;
determining the visited country or the visited network comprises extracting the inserted indication of the visited country or the visited network from the data packet;
the indication of the visited country or the visited network is inserted into a header of the data packet;
determining the visited country comprises querying the network location server to identify an indication of the set of indications of visited countries for which the first IP address is within a pool of assignable IP addresses;
determining the visited network comprises querying the network location server to identify an indication of the set of indications of visited networks for which the first IP address is within a pool of assignable IP addresses;
querying the network location server comprises subscribing to a custom geofeed of the first wireless network;
the custom geofeed comprises the set of indications of visited countries;
the computer network comprises the internet;
the indication of the visited country or the visited network comprises the MCC of the visited network;
identifying the visited network and the visited country comprises receiving, by the first wireless network, from the visited network, the MCC of the visited network over a GTP-C channel;
the data packet comprises at least a portion of a TLS connection request;
inserting, into the data packet, the indication of the visited country or the visited network;
assigning, by the first wireless network, to the UE, the first IP address in accordance with the visited country or the visited network and the set of indications of visited countries or visited networks each associated with a pool of assignable IP addresses;
publishing, at a network location server accessible by the network resource, an indication of the visited country or the visited network associated with the first IP address;
assigning, by the first wireless network, to the UE, the first IP address;
the security controls of the network resource determine the visited country or the visited network;
the security controls of the network resource determine whether to deny or allow the UE to access to the data held by the network resource;
the network resource hosts an internet exposed application;
the UE is attempting to access the internet exposed application at the network resource;
the first IP address indicates the first country in a WhoIs lookup or another public IP address geolocation service;
the pool of assignable IP addresses comprises a range of contiguous IP addresses; and
the pool of assignable IP addresses is further differentiated by regions within the visited country.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving, by a first wireless network, from a user equipment (UE), a data packet addressed to a network resource across a computer network, wherein the UE is roaming on a visited wireless network operating in a visited country, wherein the UE comprises a home subscriber of the first wireless network, wherein the UE has been assigned a first internet protocol (IP) address by the first wireless network, and wherein the first IP address indicates a first country in which the first wireless network operates but does not indicate the visited country and the visited network;
identifying, by the first wireless network, the visited network and the visited country;
inserting, into the data packet, an indication of the visited country or the visited network; and
forwarding, by the first wireless network, the data packet to the network resource.

2. The method of claim 1, further comprising:
determining, by the network resource, the visited country; and
either:
based on at least the visited country or the visited network meeting exclusion criteria, denying the UE access to data held by the network resource; or
based on at least the visited country meeting acceptability criteria, allowing the UE to access to the data held by the network resource.

3. The method of claim 2, wherein determining the visited country comprises:
extracting the inserted indication of the visited country or the visited network from the data packet.

4. The method of claim 3, wherein the indication of the visited country or the visited network is inserted into a header of the data packet.

5. The method of claim 1, further comprising:
publishing, at a network location server accessible by the network resource, an indication of the visited country or the visited network associated with the first IP address; and/or
assigning, by the first wireless network, to the UE, the first IP address in accordance with the visited country and a set of indications of visited countries each associated with a pool of assignable IP addresses; and
wherein determining the visited country comprises:
querying the network location server to identify the indication of the visited country or the visited network associated with the first IP address; or
querying the network location server to identify an indication of the set of indications of visited countries for which the first IP address is within a pool of assignable IP addresses.

6. The method of claim 1, wherein the computer network comprises the internet and wherein the indication of the visited country or the visited network comprises a mobile country code (MCC) or a mobile network code (MNC) of the visited network.

7. The method of claim 1, wherein identifying the visited network and the visited country comprises:
receiving, by the first wireless network, from the visited network, a mobile country code (MCC) of the visited network over a general packet radio service (GPRS) tunneling protocol (GTP) control plane (GTP-C) channel.

8. The method of claim 1, wherein the data packet comprises at least a portion of a transport layer security (TLS) connection request.

9. A system comprising:
a processor; and
a computer-readable medium storing instructions that are operative upon execution by the processor to:
receive, by a first wireless network, from a user equipment (UE), a data packet addressed to a network resource across a computer network, wherein the UE is roaming on a visited network operating in a visited country, wherein the UE comprises a home subscriber of the first wireless network, wherein the UE has been assigned a first internet protocol (IP) address by the first wireless network, and wherein the first IP address indicates a first country in which the first wireless network operates but does not indicate the visited country and the visited network;
identify, by the first wireless network, the visited network and the visited country;
insert, into the data packet, an indication of the visited country or the visited network; and
forward, by the first wireless network, the data packet to the network resource.

10. The system of claim 9, wherein the instructions are further operative to:
determine, by the network resource, the visited country; and
either:
based on at least the visited country or the visited network meeting exclusion criteria, deny the UE access to data held by the network resource; or
based on at least the visited country meeting acceptability criteria, allow the UE to access to the data held by the network resource.

11. The system of claim 10, wherein determining the visited country comprises:
extracting the inserted indication of the visited country or the visited network from the data packet.

12. The system of claim 11, wherein the indication of the visited country or the visited network is inserted into a header of the data packet.

13. The system of claim 9, wherein the computer network comprises the internet and wherein the indication of the visited country or the visited network comprises a mobile country code (MCC) or a mobile network code (MNC) of the visited network.

14. The system of claim 9, wherein the data packet comprises at least a portion of a transport layer security (TLS) connection request.

15. One or more computer storage devices having computer-executable instructions stored thereon, which, upon execution by a computer, cause the computer to perform operations comprising:
receiving, by a first wireless network, from a user equipment (UE), a data packet addressed to a network resource across a computer network, wherein the UE is roaming on a visited network operating in a visited country, wherein the UE comprises a home subscriber of the first wireless network, wherein the UE has been assigned a first internet protocol (IP) address by the first wireless network, and wherein the first IP address indicates a first country in which the first wireless network operates but does not indicate the visited country and the visited network;
identifying, by the first wireless network, the visited network and the visited country;
inserting, into the data packet, an indication of the visited country or the visited network; and
forwarding, by the first wireless network, the data packet to the network resource.

16. The one or more computer storage devices of claim 15, wherein the operations further comprise:
determining, by the network resource, the visited country; and
either:
based on at least the visited country or the visited network meeting exclusion criteria, denying the UE access to data held by the network resource; or
based on at least the visited country meeting acceptability criteria, allowing the UE to access to the data held by the network resource.

17. The one or more computer storage devices of claim 16, wherein determining the visited country comprises:
extracting the inserted indication of the visited country or the visited network from the data packet.

18. The one or more computer storage devices of claim 17, wherein the indication of the visited country or the visited network is inserted into a header of the data packet.

19. The one or more computer storage devices of claim 15, wherein the computer network comprises the internet and wherein the indication of the visited country or the visited network comprises a mobile country code (MCC) or a mobile network code (MNC) of the visited network.

20. The one or more computer storage devices of claim 15, wherein identifying the visited network and the visited country comprises:
receiving, by the first wireless network, from the visited network, a mobile country code (MCC) of the visited network over a general packet radio service (GPRS) tunneling protocol (GTP) control plane (GTP-C) channel.
